(19) United States
(12) Patent Application Publication
(10) Pub. No.: US 2013/0280139 A1
(43) Pub. Date: Oct. 24, 2013

(54) OXYGEN MANUFACTURING DEVICE FOR VEHICLES

(71) Applicant: Fu-Lai HAN, Tainan City (TW)

(72) Inventor: Fu-Lai HAN, Tainan City (TW)

(21) Appl. No.: 13/624,809

(22) Filed: Sep. 21, 2012

Related U.S. Application Data
(63) Continuation-in-part of application No. 13/451,831, filed on Apr. 20, 2012.

(51) Int. Cl. B01D 53/00

(52) U.S. Cl. 422/187

(57) ABSTRACT

An oxygen manufacturing device includes a compressor having a power input shaft from which the vehicle's power is introduced and an inlet end for introducing filtered air and an outlet end for outputting compressed air. A case is connected to the compressor, and the compressed air is introduced into the case. The case has a dust-removal and sterilization unit, a drain unit, a cold catalyst sterilization unit and a molecular sieve unit which divides oxygen and nitrogen. The molecular sieve unit has an oxygen outlet end for outputting oxygen. By using the power from the engine of the vehicle, the device manufactures oxygen.

This application is a continuation in part of my application filed Apr. 20, 2012, Ser. No. 13/451,831.

### FIELD OF THE INVENTION

The present invention relates to an oxygen manufacturing device, and more particularly, to an oxygen manufacturing device used in the vehicle and no electric energy is required.

### BACKGROUND OF THE INVENTION

The air in a vehicle contains less oxygen than the outside air because all of the windows are closed and the driver may feel tired and cannot focus on the traffic situations on the roads because of less oxygen. The situation may be dangerous for the driver, the passengers and the people in other vehicles. Besides, dusts, dust mites and germs in the air can harm the driver and passengers.

Taiwan Publication No. M434061 discloses an oxygen manufacturing device which has a case in which a dust-removal and sterilization unit is received. The dust-removal and sterilization unit is connected to a compressor which is connected with a drain unit. The drain unit is connected with a cold catalyst sterilization unit which is connected to a molecular sieve unit. The molecular sieve unit is connected to a first connector. A control module is connected to the case and has a second connector which is connected with a volume adjustment member having an outlet end. A power unit is connected to the case. The oxygen manufacturing device further has an oxygen monitoring device and a remote control. The outlet end is connected to a splitter which guides the oxygen to the interior of the vehicle and the engine system.

However, because the power unit uses the direct current of the battery of the vehicle so that the voltage is only 12V which can only manufacture limited amount of oxygen and cannot meet the requirements.

The present invention intends to provide an oxygen manufacturing device used in the vehicle and no electric energy is required.

### SUMMARY OF THE INVENTION

The present invention relates to an oxygen manufacturing device and comprises a compressor having a power input shaft and the compressor has an inlet end and an outlet end. The inlet end is connected with an air filter for filtering air entering the inlet end and compressed air exits from the outlet end. A case is connected to the compressor and the compressed air is introduced into the case. The case has a dust-removal and sterilization unit which is connected to the outlet end of the compressor. The dust-removal and sterilization unit is connected to a drain unit which is connected with a cold catalyst sterilization unit. The cold catalyst sterilization unit is connected to a molecular sieve unit which divides oxygen and nitrogen. The molecular sieve unit has an oxygen outlet end.

The power input shaft has a transmission wheel, and a belt is connected between the transmission wheel and a transmission shaft of an engine of a vehicle.

The dust-removal and sterilization unit is connected to the outlet end by a first pipe.

The dust-removal and sterilization unit comprises a normal filtering net, a carbon filtering member and a nano silver ions filtering member.

The dust-removal and sterilization unit is connected to the drain unit by a second pipe.

The drain unit is connected to the cold catalyst sterilization unit by a third pipe.

The cold catalyst sterilization unit is connected to the molecular sieve unit by a fourth pipe.

The present invention uses the power of the engine of the vehicle to drive the compressor so that no extra electric power is needed.

The present invention manufactures significant amount of oxygen which is used for the driver and the passengers in the vehicle. The efficiency is higher than the existed electric oxygen manufacturing devices.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the oxygen manufacturing device of the present invention;

FIG. 2 shows the parts arrangement of the oxygen manufacturing device of the present invention, and

FIG. 3 shows that the oxygen manufacturing device of the present invention is installed in a vehicle.

### DETAILED DESCRIPTION OF THE PREFERRED EMBODIMENT

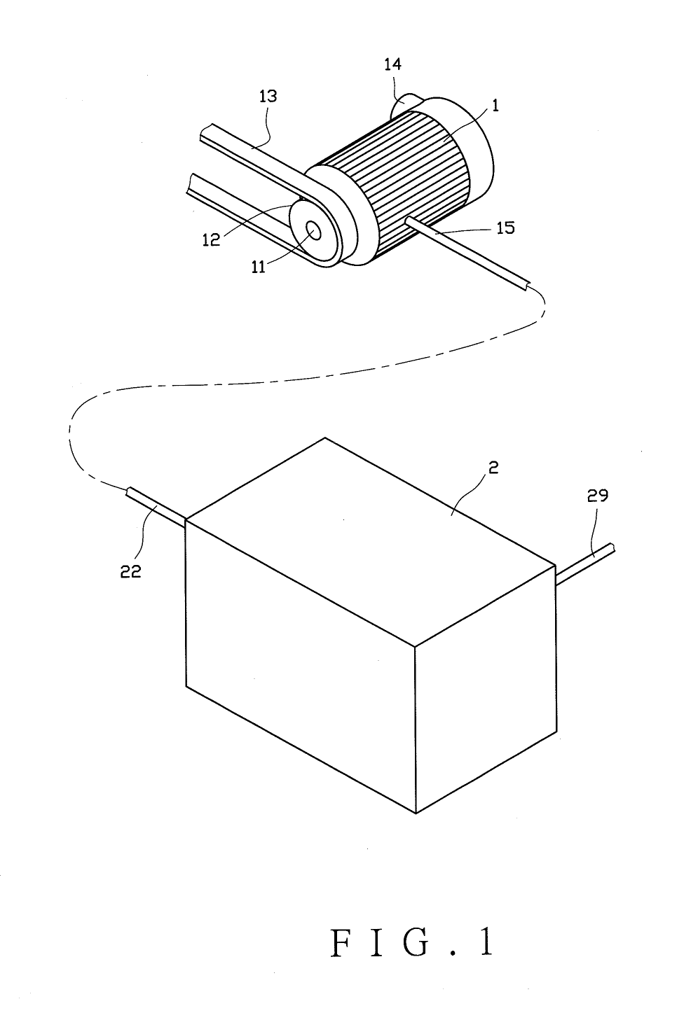

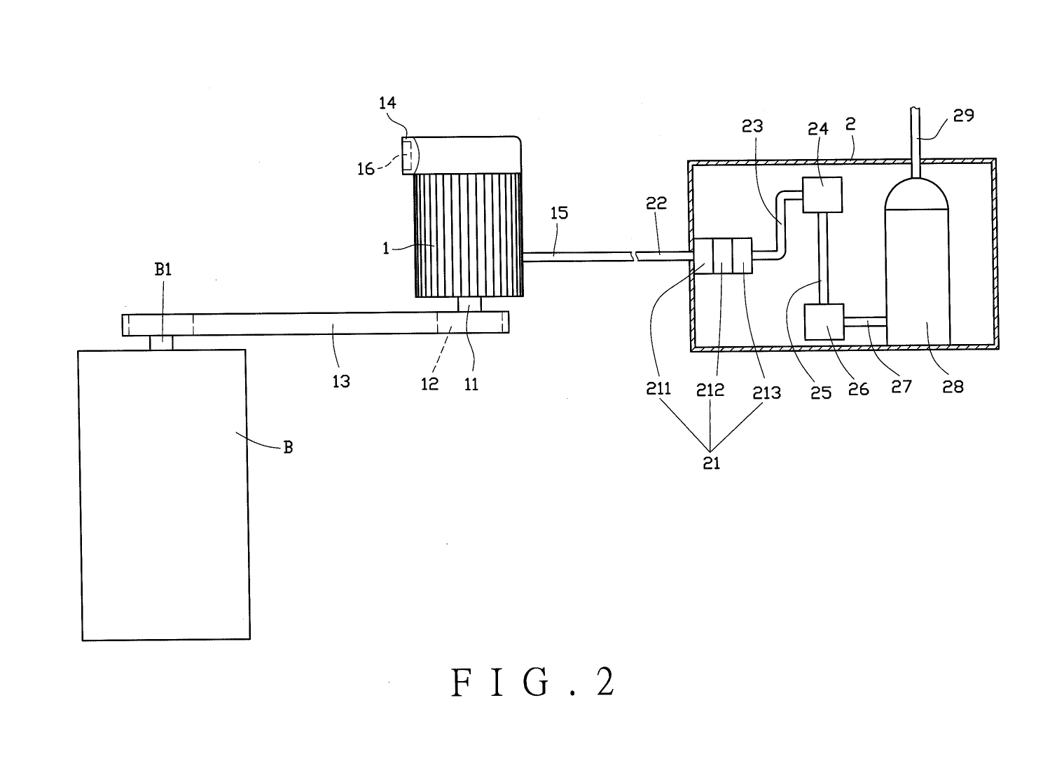

Referring to FIGS. 1 and 2, the oxygen manufacturing device of the present invention is used in a vehicle “A” and comprises a compressor 1 and a case 2.

The compressor 1 has a power input shaft 11 so as to input the power, and a transmission wheel 12 is connected to the power input shaft 11. A belt 13 is connected between the transmission wheel 12 and a transmission shaft “B1” of an engine “B” of the vehicle “A”. The belt 13 is driven by the power from the engine “B”. The compressor 1 has an inlet end 14 and an outlet end 15. The inlet end 14 is connected with an air filter 16 for filtering air entering the inlet end 14 and compressed air exits from the outlet end 15.

The case 2 is connected to the compressor 1 and the compressed air is introduced into the case 2. The case 2 has a dust-removal and sterilization unit 21 which is connected to the outlet end 15 of the compressor 1 by a first pipe 22. The dust-removal and sterilization unit 21 comprises a normal filtering net 211, a carbon filtering member 212 and a nano silver ions filtering member 213. The dust-removal and sterilization unit 21 connected to a drain unit 24 by a second pipe 23, and the drain unit 24 is connected with a cold catalyst sterilization unit 26 by a third pipe 25. The cold catalyst sterilization unit 26 generates cold catalyst. The cold catalyst sterilization unit 26 is connected to a molecular sieve unit 28 by a fourth pipe 27. The molecular sieve unit 28 divides oxygen and nitrogen. The molecular sieve unit 28 has an oxygen outlet end 29 so as to output oxygen and the nitrogen is sent out by a pipe (not shown).

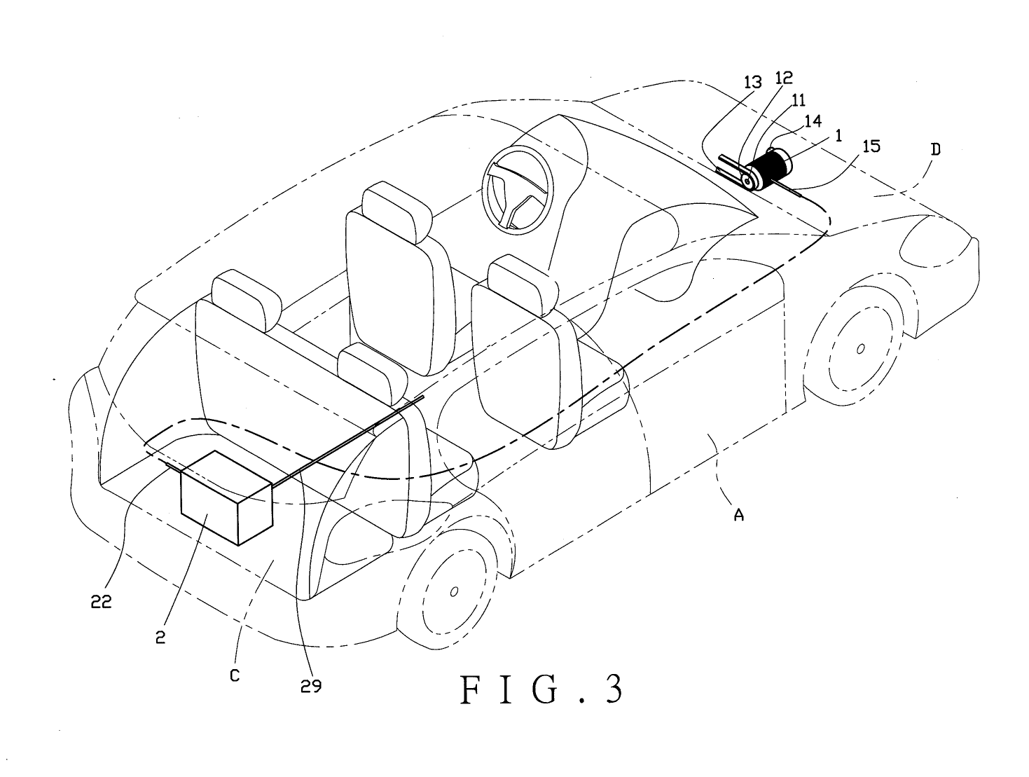

When in use, as show in FIGS. 2 and 3, the case 2 is installed to the vehicle “A” such as in the trunk C, and the compressor 1 is fixed in the engine room “D” of the vehicle “A”. The belt 13 is connected between the transmission wheel 12 and the transmission shaft “B1” of the engine “B” of the vehicle “A”, wherein the belt 13 is driven by the power from the engine “B” so as to drive the compressor 1. The outside air is sucked into the compressor 1 and compressed via the inlet end 14. The air is filtered by the air filter 16 to ensure the quality of the air and the air is compressed by using the power of the engine “B”. The compressed air exits from the outlet end 15 and is introduced to the dust-removal and sterilization unit 21 via the first pipe 22. The compressed air is then filtered by the normal filtering net 211, the carbon filtering member 212 and the nano silver ions filtering member 213. The normal filtering net 211 filters the heavy metal particles and dust, the carbon filtering member 212 removes the odor, the humidity and foreign particles, and absorbs the harmful electric waves and dust in the air, and the nano silver ions filtering member 213 kills the germs, removes odor and prevents particles in the air from being rotten. The filtered and compressed air then enters into the drain unit 24 via the second pipe 23. By the centrifugal force generated by quick spinning, the water and humidity in the compressed air is removed. The compressed air moves upward and the water flows downward and drained. The compressed air then enters into the cold catalyst sterilization unit 26 which generates cold catalyst to make degradation of organic compounds and oxygen in the compressed air to generate water and other materials which are harmless to humans. The germs and organic compounds which could cause cancers are removed under normal temperature. The compressed air then enters into the molecular sieve unit 28 via the fourth pipe 27 which uses PSA (Pressure Swing Adsorption) oxygen technology to divide the compressed air into oxygen and nitrogen. The case 2 further has a pipe (not shown) to output the nitrogen from the vehicle “A”. The oxygen generated is then introduced into the vehicle “A” via the oxygen output end 29. Because the power for the compressor 1 comes from the engine “B” so that no extra electric power is needed.

While we have shown and described the embodiment in accordance with the present invention, it should be clear to those skilled in the art that further embodiments may be made without departing from the scope of the present invention.

What is claimed is:

1. An oxygen manufacturing device comprising:
a compressor having a power input shaft, the compressor having an inlet end and an outlet end, the inlet end connected with an air filter for filtering air entering the inlet end, compressed air existing from the outlet end, and
a case connected to the compressor and the compressed air being introduced into the case, the case having a dust-removal and sterilization unit which is connected to the outlet end of the compressor, the dust-removal and sterilization unit connected to a drain unit which is connected with a cold catalyst sterilization unit, the cold catalyst sterilization unit connected to a molecular sieve unit which divides oxygen and nitrogen, the molecular sieve unit having an oxygen outlet end.

2. The device as claimed in claim 1, wherein the power input shaft has a transmission wheel and a belt is connected between the transmission wheel and a transmission shaft of an engine of a vehicle.

3. The device as claimed in claim 1, wherein the dust-removal and sterilization unit is connected to the outlet end by a first pipe.

4. The device as claimed in claim 1, wherein the dust-removal and sterilization unit comprises a normal filtering net, a carbon filtering member and a nano silver ions filtering member.

5. The device as claimed in claim 1, wherein the dust-removal and sterilization unit is connected to the drain unit by a second pipe.

6. The device as claimed in claim 1, wherein the drain unit is connected to the cold catalyst sterilization unit by a third pipe.

7. The device as claimed in claim 1, wherein the cold catalyst sterilization unit is connected to the molecular sieve unit by a fourth pipe.
